(19) United States
(12) Patent Application Publication
(10) Pub. No.: US 2025/0182153 A1
(43) Pub. Date: Jun. 5, 2025

(54) Automatic Image Composition with Item Promotion

(71) Applicant: eBay Inc., San Jose, CA (US)

(72) Inventors: Jian Pan, Shanghai (CN); Meng Sun, Shanghai (CN); Feng Xie, Shanghai (CN); Kun Yu, Shanghai (CN); Xiaojie Zang, Shanghai (CN)

(73) Assignee: eBay Inc., San Jose, CA (US)

(21) Appl. No.: 18/528,282

(22) Filed: Dec. 4, 2023

(51) Int. Cl. G06Q 30/0207; G06Q 30/0235; G06T 11/60

(52) U.S. Cl. CPC G06Q 30/0222; G06Q 30/0235; G06Q 30/0239; G06T 11/60

(57) ABSTRACT

In implementations of systems and procedures for automatic image composition for item promotions, a computing device implements the display of graphical promotion emblems associated with items listed for sale on an electronic commerce platform. An emblem is composited with a digital image of an item offered for sale, with the emblem overlapping the digital image. The emblem includes encoding that, when processed, populates a graphical promotion data field of the emblem with promotion data of the item. The display of the emblem is controlled based on the promotion data such that the emblem is displayed while the promotion is active and is hidden while the promotion is inactive.

### BACKGROUND

Service provider systems are configurable to employ digital services that are accessible via a network in support of transactions involving items and services. Such service provider systems often provide listing interfaces that support browsing of various items that are made available by a variety of vendors. Listings for such items are configurable to include information describing the items, such as item condition information, digital images depicting the items, and so forth. Further, such listings are typically configured to include the monetary price of the items offered for purchase.

Some service provider systems support a fixed pricing structure for items in which the price of each item is defined by the respective vendor offering the item for sale, and other service provider systems support an auction price structure in which users place bids or offers on items listed for sale by vendors. Service provider systems also support multiple pricing structures, with some items offered at fixed prices and other items offered for bidding. Conventional techniques used to provide listing interfaces, however, involve detailed knowledge that result in inaccuracies, user frustration, and inefficient use of computational resources, especially when confronted with management of a multitude of listings.

### SUMMARY

Techniques for automatic image composition with item promotion are described. In one or more implementations, an emblem is composited with a digital image of an item that is to be made available via a digital service, e.g., with the emblem overlapping the digital image. The emblem includes encoding that, when processed, populates a graphical promotion data field of the emblem with data relating to the item. In some instances, the data is configurable to include a promotion start date, promotion end date, and/or item discount amount. Further, in some instances, the display of the emblem is controlled based on the parameters described by the promotion data such that the emblem is displayed while the promotion is active and is hidden while the promotion is inactive.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ automatic image composition with item promotion as described herein.

FIG. 2 depicts an example implementation showing operation of a promotion management module and other components of FIG. 1 in greater detail.

FIG. 3 depicts an example implementation showing an image compositing operation of the promotion management module of FIG. 2 in greater detail.

FIG. 4 depicts an example implementation showing operation of an emblem processing module of the promotion management module of FIG. 2 in greater detail.

FIG. 5 depicts an example encoding of an emblem used in the operation of the promotion management module.

FIG. 6 depicts an example implementation showing operation of a composition attribute retrieval module of the promotion management module in greater detail.

FIG. 7 depicts an example implementation showing operation of a promotion parameter interface of the promotion management module in greater detail.

FIG. 8 depicts an example implementation showing operation of a promotion display module of the promotion management module in greater detail, with an output of the promotion display module output based on an inactive promotion.

FIG. 9 depicts an example implementation showing operation of a promotion display module of the promotion management module in greater detail, with an output of the promotion display module output based on an active promotion.

FIG. 10 illustrates an example system that includes an example computing device that is representative of one or more computing systems and/or devices for implementing the various techniques described herein.

FIG. 11 shows a flow diagram depicting a procedure in an example implementation which includes combining a digital image of an item with a promotion emblem.

FIG. 12 shows a flow diagram depicting a procedure in an example implementation which includes controlling deployment of a combined digital image and promotion emblem based on promotion data parameters.

### DETAILED DESCRIPTION

### Overview

Service provider systems are configurable to implement digital services that are made available via a network to client devices. A variety of digital services may be made available by the service provider systems, an example of which implements use of item listings to provide information to end users about items made available by a variety of providers, i.e., vendors. Such service provider systems are often implemented as websites accessible to external client devices, such as personal computers, smart phones, and so forth, over an electronic network such as the internet. Information associated with the items made available via the digital service is accessed through item listings controlled by the service provider systems, and the item listings are often organized to support the viewing of multiple item listings via a graphical user interface. For example, such service provider systems often include digital images representative of items available for purchase that are displayed in a grid-like arrangement within the graphical user interface using one or more rows and/or columns, and such digital images are often referred to as thumbnail images.

In some examples, thumbnail images are displayed adjacent to textual elements, such as compact item descriptions and/or item prices, that provide abbreviated details about the item listings. The full item listings are often accessible through interaction with the thumbnail images. As one example, interaction with a thumbnail image depicting a product causes the graphical user interface to transition from display of the multiple thumbnail images associated with different item listings to display of the item listing of the product depicted by the selected thumbnail image. The transition of the graphical user interface, for example, navigates the graphical user interface from display of a webpage including multiple thumbnail images to display of a webpage including the selected item listing along with information describing the listed item.

In an effort to increase interest directed toward item listings, the item listings are sometimes edited to include promotions. Examples of promotions include price reductions of items, bundles of items offered at a discounted price relative to the combined cost of the items when purchased individually, and other types of incentives. However, conventional service provider systems are challenged with the implementation of short-term modifications to item listings, including modifications intended for the promotion of item listings. For example, with some conventional techniques, the price of an item within an item listing is fixed according to item listing parameters set at the time of creation of the item listing. Although such item listings are sometimes manually editable, manual editing of the price included within the item listing via conventional techniques replaces the original price of the item with the edited price. If a return to the original price is desired at some later time, the item listing is once again manually edited to adjust the edited price back to the original price.

Some conventional techniques support the display of a promotion price associated with an item as a plain textual element displayed adjacent to the thumbnail image of the item. However, plain textual elements often struggle to attract user attention and can result in lackluster amounts of user interaction with the item listings. Other conventional techniques support replacing the thumbnail image depicting the listed item with a manually-created thumbnail image including additional graphical elements to attempt to increase user interaction with the item listing. The thumbnail image is typically a flat raster image, such as digital photograph formatted as a JPEG image.

Manual creation of images typically includes use of an image editing application to incorporate graphical elements directly into the image, e.g., with the additional graphical elements depicted by pixels of the image. However, these conventional approaches are time consuming and are dependent on access to an appropriate image editing application as well as the knowledge to operate such an application. Further, replacement of the image increases a load on the systems implementing the ecommerce platform and increases consumption of computer memory and/or processor power of the systems. This increased load is compounded when images are frequently changed, such as for shorter promotions, e.g., single day promotions, or promotions that are cycled several times over a relatively short time span.

Accordingly, automatic image composition with item promotion techniques are described that address these technical challenges. In one or more implementations, promotions of item listings are employed to display graphical emblems (e.g., in an overlapping arrangement) with digital images of the listed items. To do so, the emblems are maintained separately from the digital images and include encoding that, when executed, populates the emblems with promotion parameters retrieved from promotion data of the listed items. The emblems populated with promotion parameters are combined with the digital images during times that the promotions are active, and the emblems are not displayed during times that the promotions are inactive.

In this way, increased visual representation of promotions associated with listed items is supported via the emblems. Further, because the emblems are populated with promotion parameters retrieved from the promotion data, on-the-fly changes to the promotion parameters displayed by the emblems are supported without modification of the digital images included by the item listings. As a result, resource consumption associated with generation of digital images incorporating promotion parameters is reduced or eliminated, and an ease of adjusting the graphical representation of promotions is increased.

A promotion management module, for instance, receives a digital image of an item from an item listing. The promotion management module further receives a selection of a promotion emblem. The promotion management module identifies promotion data of the item from a promotion dataset, and additionally identifies one or more graphical promotion data fields of the promotion emblem. By executing instructions stored within an encoding of the emblem, the graphical promotion data fields of the emblem are populated with promotion parameters from the promotion data. In an implementation, the emblem populated with the promotion parameters is combined with the digital image of the item. Further, in some implementations, combining the emblem with the digital image is non-destructive to the digital image such that the emblem overlaps the digital image but does not modify pixels included by the digital image.

The promotion management module is further employable to control deployment of promotions based on the promotion data. The promotion data associated with an item listing includes a promotion start date, a promotion end date, and a promotion discount rate, in some implementations. The promotion management module compares a current date to the promotion start date and the promotion end date to determine whether a promotion associated with the item listing is active or inactive. While the promotion is active, the promotion management module displays the emblem populated with the promotion parameters in the overlapping arrangement with the digital image of the item offered via the item listing. While the promotion is inactive, the emblem is not displayed. In some implementations, the promotion management module further controls an appearance of the emblem based on the promotion data.

Consider a scenario in which an item is listed for sale via an item listing configured through an e-commerce platform of a service provider system. The item listing includes an item price, item description, and a digital image depicting the item. The digital image of the item is displayed as a thumbnail image within a graphical user interface supported by the service provider system, such as a webpage including multiple thumbnail images each representing a different item listing.

To increase user interest in the item listing, a promotion associated with the item listing is defined through the promotion management module of the service provider system. In defining the parameters of the promotion, a promotion start date, a promotion end date, and a promotion discount amount are selected via user input. Additionally, a promotion emblem is selected from among a plurality of different promotion emblems. A promotion parameter interface employed by the promotion management module is used to define display properties of the emblem, such as a size, placement, and/or rotation of the emblem relative to the digital image of the item. The promotion parameters are stored as promotion data within a promotion dataset.

In this scenario, the promotion start date is defined as one week after the date of the creation of the item listing, and the promotion end date is defined as two weeks after the date of the creation of the item listing. The initial price of the item is defined, and the promotion discount amount is defined.

Throughout the first week following the creation of the item listing, the item listing is represented by the digital image of the item when viewed alongside other item listings. However, during the second week following the creation of the item listing, e.g., at the beginning of the promotion start date, the promotion management module processes the emblem to execute the instructions stored within the encoding of the emblem. The processing of the emblem populates graphical data fields of the emblem with the promotion parameters including the promotion discount amount and the promotion end date.

The promotion management module then combines the populated emblem with the digital image in a manner non-destructive to the digital image. In this configuration, the emblem and the digital image are separate entities or objects, with the emblem overlapping a portion of the digital image. The combined emblem and digital image are displayed together as the thumbnail image representing the item listing throughout the span of time between the promotion start date and the promotion end date. Further, in some instances, the combined emblem and digital image are displayed together in the item listing itself. The promotion management module thus maintains the digital image as representing the item listing and layers the emblem on top of the digital image. The graphical data fields populated with the promotion parameters display the promotion end date and the promotion discount amount. Following the conclusion of the second week, e.g., at the end of the promotion end date, the promotion management module ceases displaying the emblem over the digital image to indicate that the promotion is inactive.

In this way, the system supports automatic composition of promotion images in accordance with promotion parameters. In particular, during times in which a promotion is active, the selected emblem associated with the item listing is populated with the information describing the promotion, e.g., the promotion parameters, and the populated emblem is automatically composited with the digital image. Additionally, during times in which the promotion is not active, the composited emblem and digital image is automatically replaced with the original digital image, e.g., the digital image displayed without the emblem. As a result, an ease of controlling the timing and presentation of the promotion is increased.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

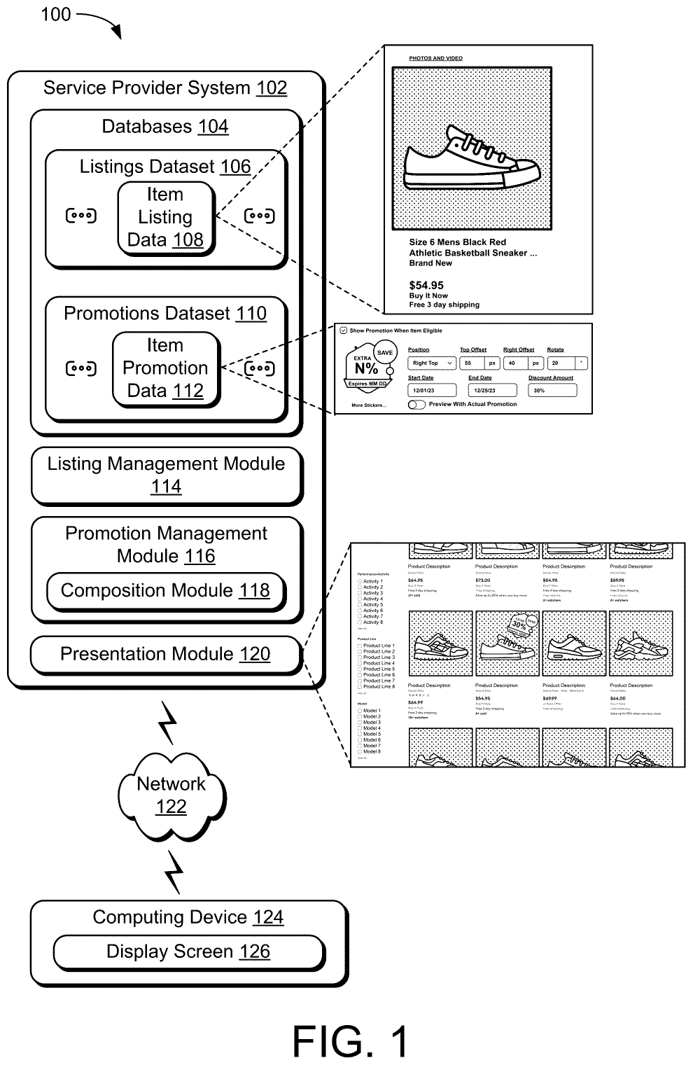

FIG. 1 is an illustration of a digital medium environment 100 in an example implementation that is operable to employ automatic image composition with item promotion techniques described herein. The illustrated environment 100 includes a service provider system 102, which is configurable in a variety of ways.

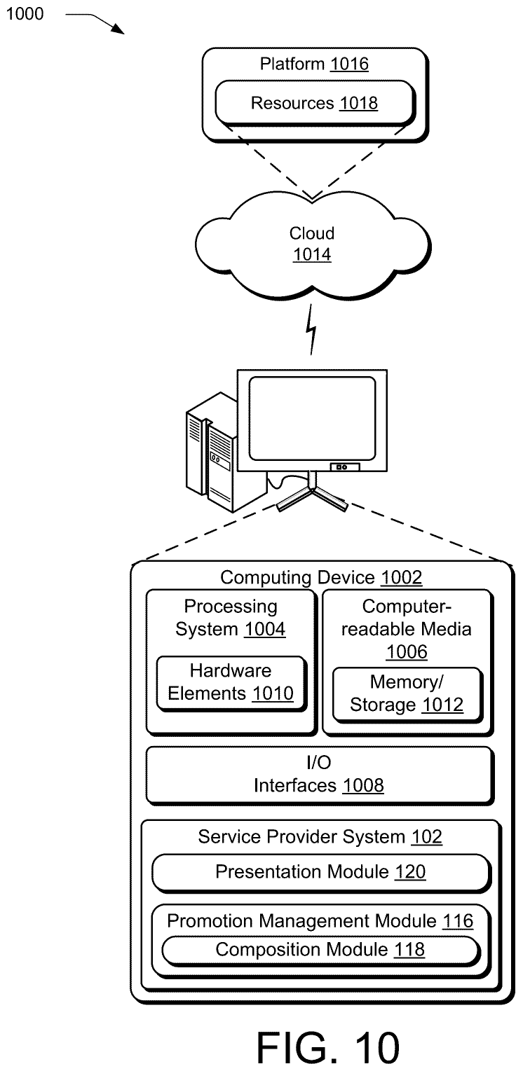

The service provider system 102 is a computing device, or multiple computing devices communicatively coupled to each other, and is configured to support operation of the modules and other systems described herein. In particular, the service provider system 102 supports the modules and systems described herein to implement a platform such as an electronic commerce (e-commerce) website or other online marketplace accessible to end users via other electronic devices such as personal computers, smartphones, and so forth. For instance, the service provider system 102 is configurable to include electronic storage media, transitory memory and non-transitory memory, one or more electronic processors, and other components configured to facilitate operation of the online marketplace. The service provider system 102 in some instances includes multiple servers, databases, and/or other electronic devices to support storage of data such as item listings, digital images, item promotion parameters, and other data associated with operation of the service provider system 102 and/or content provided by the service provider system 102 to end users. In such configurations, the multiple servers and/or other electronic devices are utilized to perform operations “over the cloud” as described in relation to FIG. 10.

The service provider system 102 is operable to implement a platform (e.g., an ecommerce platform) accessible to end-users over a network 122. The network 122 in some instances is the internet, and the service provider system 102 employs the platform as a website accessible via computing devices external to the service provider system 102, such as computing device 124 including display screen 126.

The service provider system 102 includes various modules, systems, and other components that are in electronic communication with each other. In some instances, the components communicate electronically with each other via wired connections between the components. The components, for example, communicate electronically with each other via wireless connections between the components, e.g., via Wi-Fi or other wireless electronic signals. Components are configurable to communicate electronically with each other via wired connections, and some components communicate electronically with each other via wireless connections. As an example of electronic communication, databases 104 are operable to electronically communicate with other components of the service provider system 102, such as promotion management module 116, to provide data to the other components and/or receive data from the other components electronically.

The service provider system 102 is shown including listing management module 114, promotion management module 116, presentation module 120, and databases 104, each described in further detail below. The listing management module 114 is employed by the service provider system 102 for the creation, modification, management, and removal of item listings. To facilitate the operations performed by the listing management module 114, the listing management module 114 is in electronic communication with databases 104. The databases 104 include a listings dataset 106, which in some instances includes data describing each item listing, such as item listing data 108 associated with a single item listing. The listing management module 114 receives item listing data from the databases 104. Further, the listing management module 114 is operable to store item listing data describing newly-generated item listings within databases 104 and/or to update item listing data within the databases 104, e.g., within the listings dataset 106.

The promotion management module 116 is employed by the service provider system 102 for the creation, modification, management, and removal of promotions associated with the item listings. Different item listings are configurable with different promotion parameters, and the promotion parameters of the items listings are stored as promotion data within promotions dataset 110 of databases 104. The promotions dataset 110 includes data describing each promotion, such as item promotion data 112 associated with a promotion of a single item listing. In some instances, a promotion defines temporary modifications to item listing parameters that are applied to an item listing. As one example, an active promotion applied to an item listing modifies an initial price of the item as described by the item listing to a discounted price. The discounted price in some instances is based on a percentage of the initial price, e.g., 50% of the initial price.

Further, according to the techniques described herein, an active promotion applied to an item listing temporarily modifies an appearance of an image depicting the item in the item listing. In particular, the promotion management module 116 includes a composition module 118 that is employed by the promotion management module 116 to overlay a graphical promotion emblem with a digital image depicting the item in the item listing.

In some instances, the digital image is shown overlapped by the emblem within the item listing and outside of the item listing. For example, the item listing is configurable as a webpage, with the webpage displaying the digital image and item listing parameters such as the item description, item price, and so forth. The item listing is further representable by the digital image in other areas of the e-commerce platform. As one example, the service provider system 102 employs presentation module 120 to define a user interface of the e-commerce platform including thumbnail images representing the item listings controlled by listing management module 114. The user interface is configurable as a webpage in some instances. Each thumbnail image depicts a listed item, and each thumbnail image links to the respective item listing of the item depicted by the thumbnail image. Implementing a promotion via the promotion management module 116, in some instances, includes overlaying the emblem with the digital image of the item within the item listing itself and additionally overlaying the emblem with the thumbnail image depicting the listed item outside of the item listing. The thumbnail image is based on the digital image of the item in some instances, e.g., the thumbnail is configurable as a reduced-size version of the digital image depicting the item within the item listing.

To implement the emblem as associated with the digital image, the promotion management module 116 processes an encoding of the emblem to populate graphical data fields of the emblem with promotion parameters defined by the promotion data according to the techniques described herein. Then, in some instances, the composition module 118 of the promotion management module 116 combines the populated emblem with the digital image without modifying pixels of the digital image via HyperText Markup Language (HTML) synthesis. For example, as described above, each item listing is configurable as a webpage. Employing the composition module 118 to combine the emblem with the digital image via HTML synthesis for an item listing webpage includes forming an HTML element, such as an HTML DIV element, within the webpage. An HTML IMG tag is set within the DIV element with a Uniform Resource Locator (URL) of the IMG tag directed toward the network location of the digital image. The emblem is retrieved (e.g., downloaded) from the databases 104 as a string and embedded within the DIV element or appended to the DIV element.

Textual elements within the emblem string are updated to include the promotion parameters from the item promotion data. Update of the textual elements includes, in some instances, processing encoding of the emblem (e.g., encoding within the emblem string) to retrieve the promotion parameters and to embed the promotion data within the emblem, e.g., replace the processed encoding with the promotion parameters. In some implementations, update of the textual elements utilizes JavaScript Object Notation (JSON), and in some implementations, the emblem is configurable as a scalable vector graphic (SVG) image, where the string is defined according to an SVG image encoding structure. For example, the content of the string defines various properties of the emblem such as a shape of vector paths included by the emblem, a color of portions of the emblem, and so forth. In some instances, the SVG image includes vector content such as vector paths and vector curves and does not include pixel content.

In some instances, the promotion management module 116 employs the composition module 118 to combine the digital image with the emblem in a manner that updates pixels of the digital image to depict the emblem. For example, during conditions in which a particular condition is satisfied the promotion management module 116 combines the digital image and the emblem as a single flattened image as described herein. The particular condition, for instance, includes an affirmative determination that the promotion is to be displayed at an off-platform location such as a social media network. The determination that the promotion is to be displayed off-platform is based on user input in some instances, e.g., input applied to a “share” button included by the item listing. Combination of the digital image with the emblem in this way ensures that the emblem is included with the digital image during conditions in which the item listing is promoted off-platform, e.g., outside of the environment 100 of the service provider system 102 and through separate social media networks, external websites, and the like. Off-platform webpages or networks often have a variety of different configurations, which increases a difficulty of reliably pairing the emblem with the digital image via HTML synthesis as described above. However, by integrating the emblem within the pixels of the digital image, the combined digital image and emblem supports reliable display at off-platform locations having various configurations.

To do so, the composition module 118 is employed to create a buffer, e.g., a temporary storage space within databases 104 or elsewhere such as within non-transitory memory. The digital image and the emblem are loaded or imported separately into the buffer, and the composition module 118 generates a virtual Document Object Model (DOM) document or environment including an object element that receives the emblem and digital image. For example, the emblem is layered over the digital image within the virtual DOM document in some instances. The emblem is configured as a string, similar to the example described above. Textual elements within the emblem string are updated to include the promotion parameters from the item promotion data.

The composition module 118 then employs a composite Application Programming Interface (API) implemented by the service provider system 102 in some instances to merge the populated emblem with the digital image. Merging the populated emblem with the digital image via the composite API combines and flattens the populated emblem and the digital image together to form a single raster image, with pixel content of the flattened image providing a visual appearance of the populated emblem overlapping the digital image. The flattening occurs subsequent to the layering of the emblem over the digital image in some instances. In the single raster image, the populated emblem and digital image are not separate entities, e.g., are not maintained separate to each other and are instead integrated together as the pixel content of the single raster image. The resulting composite image formed from the digital image and the emblem is then provided as desired to off-platform webpages and/or networks, and the visual relationship between the digital image and the emblem is maintained.

In some instances, the promotion management module 116 generates two versions of the composite image. A first version of the composite image includes the digital image and the emblem as separate entities for use within the e-commerce platform. A second version of the composite image includes the digital image and the emblem together as a single flattened image for off-platform use, e.g., outside of the e-commerce platform.

Thus, by combining the emblem and digital image in the overlapping arrangement as described herein, an ease of updating the promotional parameters displayed by the graphical fields of the emblem is increased. For example, updates to the promotion parameters are immediately (e.g., automatically) applied to the graphical fields of the emblem in such configurations without generating additional images and without modification of image pixels.

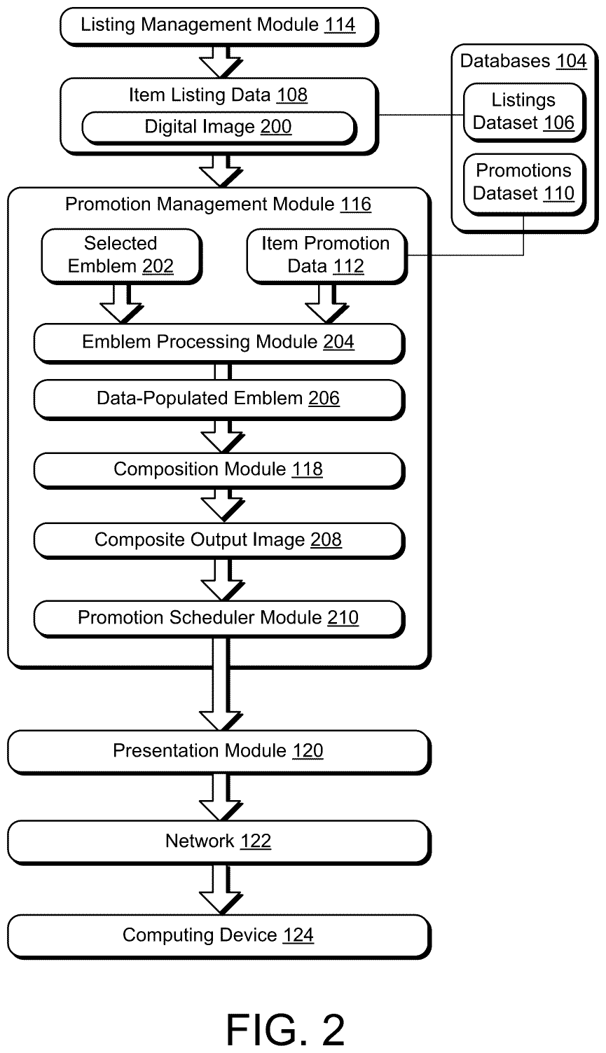

This update technique conserves processing power of the service provider system 102 and results in increased responsiveness of the e-commerce platform. During conditions in which off-platform use of the emblem and digital image is anticipated, the emblem is integrated into the digital image by altering the pixels of the digital image to depict the emblem. This implementation increases a likelihood that the emblem and digital image are shown together in the desired arrangement regardless of the configurations of off-platform websites and/or networks. The promotion management module 116 therefore increases the efficiency in managing promotions within the e-commerce platform implemented by the service provider system 102. The promotion management module 116 additionally increases reliability in maintaining the digital images and emblems together outside of the e-commerce platform. The promotion management module 116, and operations performed by the promotion management module 116, are described in further detail below with reference to FIGS. 2-9. Various aspects of other components of the service provider system 102 are described below that support the operations performed by the promotion management module 116.

The presentation module 120 included by the service provider system 102 supports operation and display of an interface through which devices external to the service provider system 102, such as computing device 124, interact with the service provider system 102 and view content hosted by the service provider system 102, such as item listings. The presentation module 120 is in electronic communication with other components of the service provider system 102 such as the databases 104, listing management module 114, and promotion management module 116, and outputs a user interface accessible by devices external to the service provider system 102 for interaction with the various components of the service provider system 102. For example, the user interface output by the presentation module 120 is configurable as a web user interface, e.g., a website, with access to editing, creation, and removal of item listings provided via the web user interface. The presentation module 120 communicates with devices external to the service provider system 102 via network 122, e.g., the internet. Devices external to the service provider system 102, such as computing device 124, display the user interface output by the presentation module 120 via a display device, such as display screen 126.

The databases 104 include non-transitory storage media configured to store data used in the listing of items via listing management module 114 and the control of promotions via promotion management module 116. For instance, databases 104 are shown that include a listings dataset 106 and promotions dataset 110. The listing management module 114 communicates electronically with databases 104 and the databases 104 provide the listing management module 114 with access to the listings dataset 106. The listing management module 114 receives the listings dataset 106 from the databases 104 in some instances. Further, promotion management module 116 communicates electronically with databases 104 and the databases 104 provide the promotion management module 116 with access to the promotions dataset 110. The promotion management module 116 receives the promotions dataset 110 from the databases 104 in some instances.

The data describing an item listing is referred to as the item listing data, and the listings dataset 106 is configurable to include multiple different sets or instances of item listing data, such as item listing data 108. Each set or instance of item listing data, such as the item listing data 108, is associated with a single item listing, and the databases 104 support storage of item listing data for multiple item listings, e.g., hundreds of item listings, within listings dataset 106. Further, databases 104 support storage of multiple listing datasets each including item listing data for multiple item listings, in some instances. Each item listings dataset is configurable to include item listing data associated with items of a certain type or category. For example, a first item listings dataset is configurable to include item listing data associated with items of a first type such as footwear, a second item listings dataset is configurable to include item listing data associated with items of a second type such as upper body apparel, and so forth.

The item listing data 108 shown by FIG. 1 represents various listing data associated with a single item and used in the listing of the item. For instance, item listing data 108 is configurable to include a digital image of the associated item, a price of the item, a written description of the item, a condition of the item, and so forth. The item listing data 108 therefore represents a grouping of data associated with the item that is used for the listing of the item via the listing management module 114. Each item listed via the listing management module 114 includes a respective grouping of item listing data which is stored within databases 104. For example, a first item listed by listing management module 114 is associated with a first grouping of data defined by the item listing data 108, a second item listed by listing management module 114 is associated with a second grouping of data defined by another instance of item listing data included by the listings dataset 106, and so forth.

The promotions dataset 110 includes promotion data associated with items for listing via the listing management module 114. The promotions dataset 110 is shown including item promotion data 112 as one example of promotion data of an item. In some instances, the promotions dataset 110 includes promotion data for multiple items in addition to the item promotion data 112 shown by FIG. 1. For example, promotions dataset 110 is configurable to include promotion data for each item listed by the listing management module 114.

The item promotion data 112 shown by FIG. 1 represents various promotion data associated with a single item, e.g., a grouping of promotion data of the item. The promotion data is used by the promotion management module 116 to control promotions of the item according to the techniques described herein. The item promotion data 112 in some instances includes data describing promotion parameters such as a promotion start date, promotion end date, item discount amount, an active promotion pause indication or inactive promotion pause indication, and so forth. Each grouping of promotion data included by the promotions dataset 110 includes data describing promotion parameters similar to those described above for a respective item, e.g., an item listed by the listing management module 114.

Each instance of item listing data stored within databases 104, e.g., within listings dataset 106, is configurable to reference a respective instance of item promotion data stored within databases 104, e.g., within item promotion data 112. For example, an instance of item listing data describes listing parameters for a listing of an item, such as a name of the item, a price of the item, a description of the item, and so forth. A corresponding instance of promotion data is linked to the item listing data, e.g., referenced by the item listing data, such that the item listing data and item promotion data are each implemented in the same item listing.

As one example, the listings dataset 106 and the promotions dataset 110 are each structured as arrays of data, with each instance of item listing data assigned to a respective index of the listings dataset 106 and with each instance of item promotion data assigned to a respective index of the promotions dataset 110. A given instance of item listing data included within the listings dataset 106 is configurable to include the index of the instance of item promotion data within promotions dataset 110 utilized for the same item listing, or vice versa. Consider an example item listing for a shoe. Item listing data used for the item listing of the shoe has an index value of “225” in the listings dataset 106. Further, in the example, the promotion data associated with the item listing of the shoe has an index value of “225” in the promotions dataset 110, such that the listing data and promotion data used for the listing of the shoe are easily paired to each other.

An “instance of item listing data” or “set of item listing data” as described herein refers to item listing data describing item listing parameters for a single item listing, where the single item listing describes a single item or a single grouping of identical items. For example, a single item listing includes a description, price, and other information of a particular item offered for purchase via the e-commerce platform, and a quantity of identical items available is also included in the single item listing in some instances. As one example, a single item listing describes an item available for purchase with a quantity of fifty available, with each item of the quantity of fifty items being identical to each other item of the quantity of fifty items.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Automatic Image Composition And Item Promotion Management

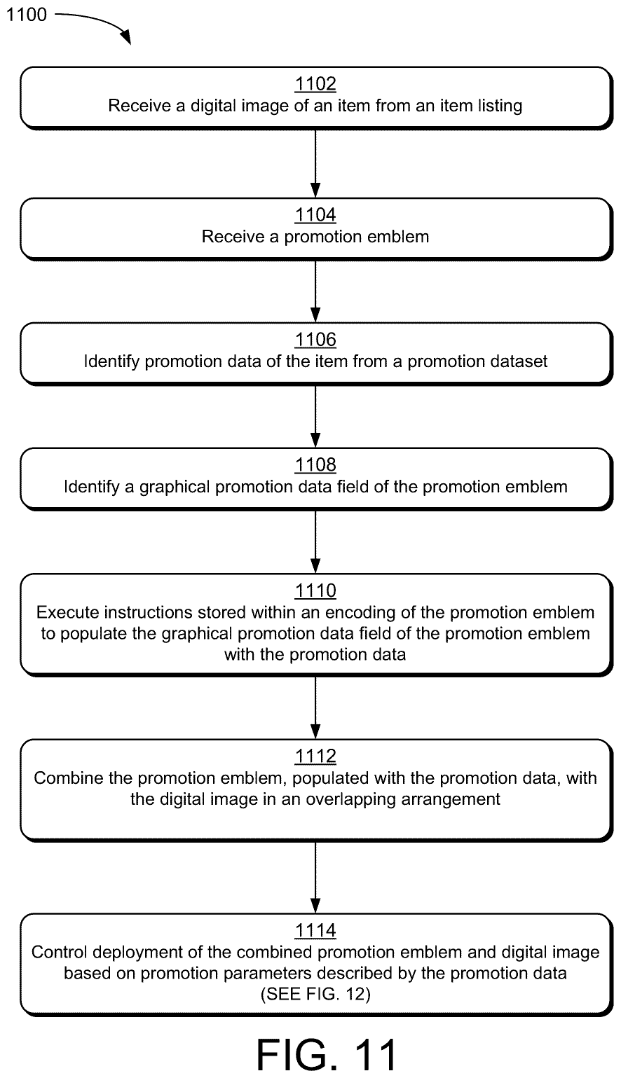

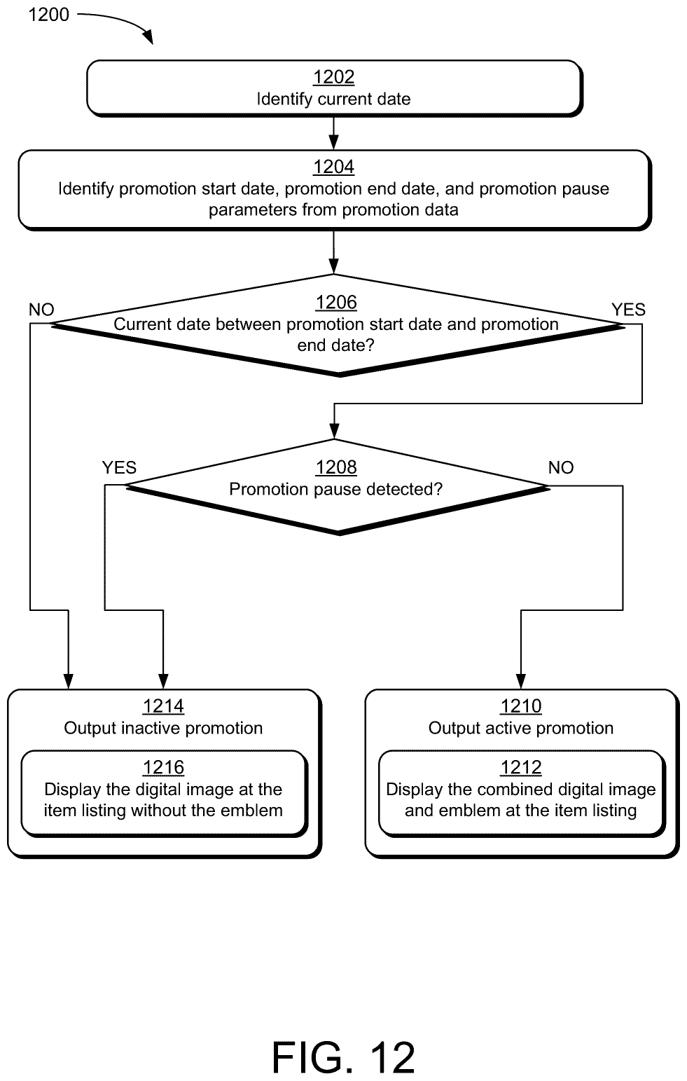

The following discussion describes automatic image composition with item promotion techniques that are implementable utilizing the described systems and devices. Aspects of the procedure are implemented in hardware, firmware, software, or a combination thereof. The procedures are shown as sets of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 11 shows a flow diagram depicting an algorithm as a step-by-step procedure 1100 in an example implementation of operations performable for accomplishing a result of automatic image composition with item promotion parameters. In some instances, the procedure 1100 includes a procedure 1200 for controlling an item promotion based on the promotion parameters as shown by the diagram of FIG. 12, with procedure 1200 performed as a portion of procedure 1100. In portions of the following discussion, reference will be made to FIGS. 2-9 in parallel with the procedure 1100 of FIG. 11 and the procedure 1200 of FIG. 12.

FIG. 2 depicts an example implementation showing operation of the various components of service provider system 102 of FIG. 1 in greater detail. In particular, FIG. 2 shows operation of the promotion management module 116 to perform the automatic image composition and item promotion management techniques described herein. FIGS. 2-9 described below each show various modules and other components included by the service provider system 102, with the components employed to perform the techniques described herein. For example, FIG. 2 shows emblem processing module 204 and promotion scheduler module 210, which, although not shown in FIG. 1, are included by the promotion management module 116, and promotion management module 116 is in turn included by service provider system 102.

To begin in this example, listing management module 114 is employed to provide item listing data 108 to promotion management module 116. In some instances, the item listing data 108 is provided directly from databases 104 to the promotion management module 116, and in some instances, the listing management module 114 retrieves the item listing data 108 from the databases 104 prior to providing the item listing data 108 to the promotion management module 116. For example, listing management module 114 is configurable to communicate electronically with databases 104 to retrieve item listing data from databases 104 for displaying item listings responsive to user requests.

Each item listing managed by the listing management module 114 is configurable as a respective web page based on the item listing data. For instance, item listing data 108 includes information about a listed item such as a written description of the listed item, digital image of the listed item, price of the listed item, and so forth. The listing management module 114 utilizes the item listing data 108 to populate the associated listing of the item with the information about the listed item.

The listing management module 114 is further operable to create and/or remove item listings, e.g., responsive to user requests. For example, the listing management module 114 supports creation of new item listings, with listing data of the new item listings stored via databases 104, e.g., within listings dataset 106 shown by FIG. 1. The listing management module 114 further supports editing and removal of existing listings including listing data stored within databases 104. Editing an item listing includes updating the respective item listing data stored within the databases 104, and removal of an item listing includes removal of the respective item listing data stored within the databases 104.

The item listing data 108 stored in databases 104 includes digital image 200, which is provided with the item listing data 108 to promotion management module 116 (block 1102 of FIG. 11). Digital image 200 is an image depicting an item listed via listing management module 114. In some instances, the digital image 200 is formatted as a JPEG, PNG, GIF, or other type of digital image file format. Although digital image 200 is shown, in some examples a listed item includes multiple digital images, such as images showing different views or perspectives of the item. The digital image 200 is thus shown as one example image included in the item listing data 108. However, the composition module 118 of the promotion management module 116 is operable to combine each digital image included by the item listing data 108 individually with selected emblem 202 according to the techniques described herein. This results in a plurality of composite images, with each composite image based on a respective digital image in combination with the selected emblem 202.

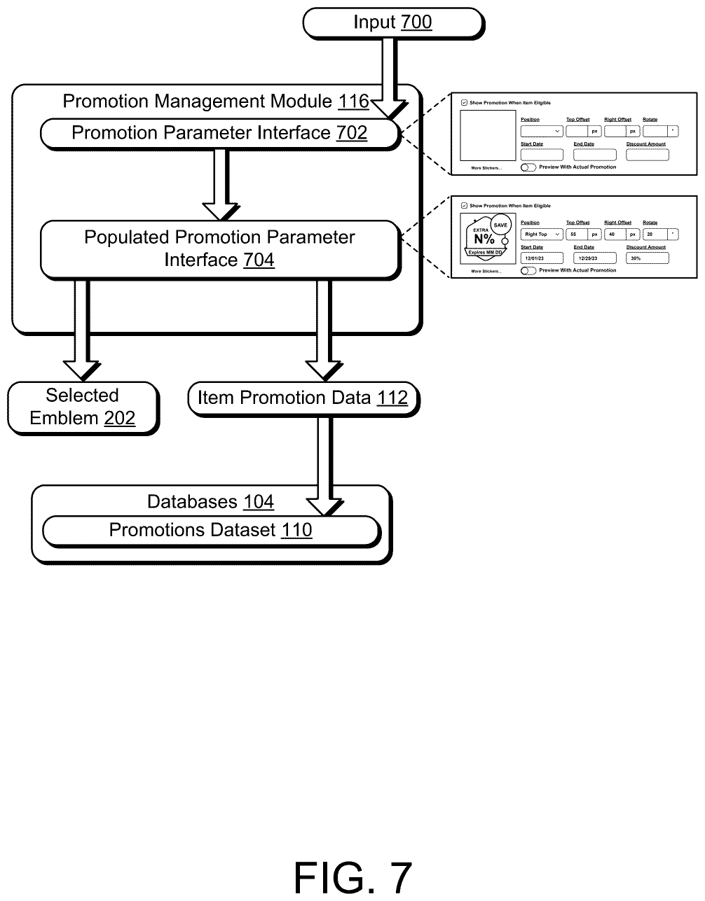

The promotion management module 116 receives the digital image 200 with the item listing data 108 as described above. The promotion management module 116 additionally receives a selected emblem 202 (block 1104 of FIG. 11) and item promotion data 112 of the item identified from promotions dataset 110 (block 1106 of FIG. 12). The selected emblem 202 is selected based on user input applied to a promotion parameter interface as described further below with reference to FIG. 7, in some instances. Although the item promotion data 112 is shown received from the databases 104, in some instances the item promotion data 112 is also received via the promotion parameter interface.

The item promotion data 112 includes information describing parameters of a promotion of a listed item. A promotion of a listed item, for example, includes a discount applied to a non-promotion price of the item as defined by the listing data of the item, e.g., item listing data 108. During conditions in which an item promotion is active, the promotion replaces the non-promotion price of the item with the updated promotion price. As one example, a listed item includes a non-promotion price equal to “$100.00.” A promotion of the listed item has a discount amount of “30%,” and while the promotion is active, the promotion price of “$70.00” replaces the non-promotion price within the item listing. Following conclusion of the promotion, the promotion price is withdrawn and the item listing is updated to once again include the non-promotion price of “$100.00.” In some instances, the item listing displays each of the non-promotion price and the promotion price during conditions in which the promotion is active.

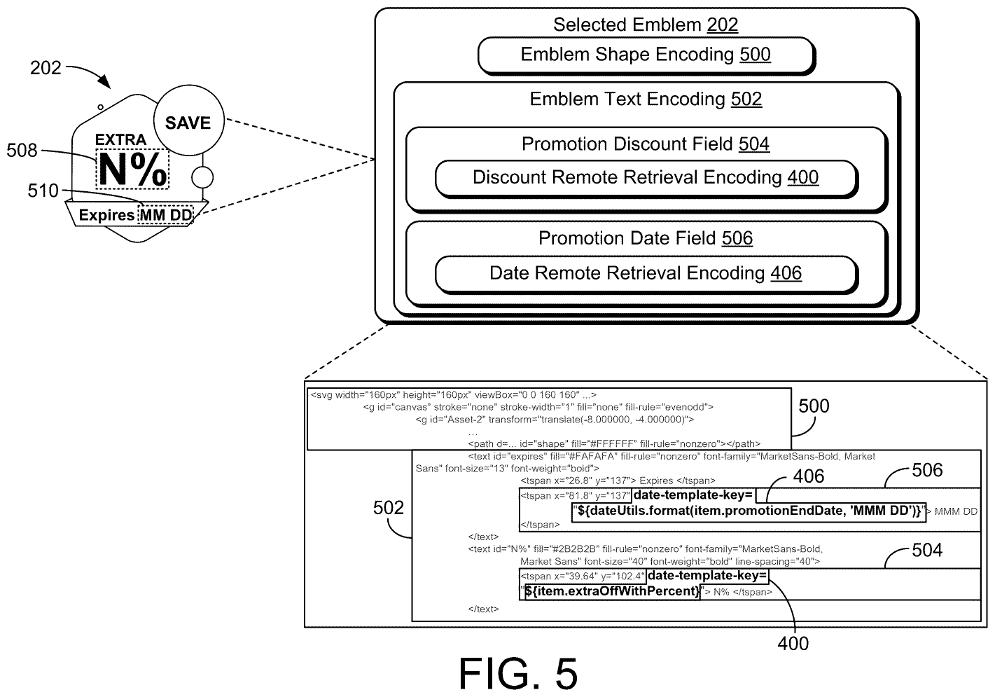

The promotion management module 116 identifies one or more graphical promotion data fields of the selected emblem 202 based on an encoding of the promotion emblem (block 1108 of FIG. 11). For example and as described below with reference to FIG. 5, the selected emblem 202 is configurable as a scalable vector graphic (SVG) image file including various graphical data fields defined by the encoding of the selected emblem 202.

The promotion management module 116 processes the selected emblem 202 to populate graphical data fields of the selected emblem 202 with the item promotion data 112. To do so, the promotion management module 116 employs emblem processing module 204 to execute instructions stored within the encoding of the selected emblem 202 (block 1110 of FIG. 11). An example of executable instructions included by the selected emblem 202 is described further below with reference to FIG. 5.

The selected emblem 202 is one of a plurality of different emblems included in a set of emblems, in some instances. For example, a variety of different emblems are selectable via the promotion management module 116, where each emblem includes different characteristics such as different shapes, colors, and so forth. In some instances, the emblems are stored in databases 104 and are received by the promotion management module 116 via electronic communication between the promotion management module 116 and the databases 104. The selected emblem 202 is identified from the set of emblems based on user input, e.g., user selection of the selected emblem 202 via the promotion parameter interface supported by presentation module 120. Each emblem includes encoding that, when processed by the promotion management module 116, populates the emblem with promotion data of the item according to the techniques described herein.

The selected emblem 202 populated with the promotion data following the processing of the selected emblem 202 via the emblem processing module 204 is referred to as data-populated emblem 206. Data-populated emblem 206 includes graphical data fields populated with the promotion data to visually display promotion parameters such as promotion discount amount and promotion dates.

The data-populated emblem 206 is combined in an overlapping arrangement with the digital image 200 via composition module 118 to form a composite output image 208 (block 1112 of FIG. 11). The composite output image 208 is also referred to herein as a combined image. In some instances, the composite output image 208 includes the digital image 200 and the data-populated emblem 206 maintained as separate entities that are layered in the overlapping arrangement, where the overlapping of the data-populated emblem 206 with the digital image 200 is non-destructive to the digital image 200. For example, the digital image 200 is configurable as a raster image, such as a photograph in JPEG format, and the data-populated emblem 206 is configurable as a vector image, such as an SVG format image. In some instances, the digital image 200 includes pixel content and does not include vector content such as vector paths or vector curves.

The composite output image 208 is configurable as a layering of the data-populated emblem 206 over the digital image 200, e.g., with a z-order of the data-populated emblem 206 being higher than a z-order of the digital image 200. In this configuration, the data-populated emblem 206 does not modify data of the digital image 200, e.g., does not alter pixels included by the digital image 200. Thus, the forming of the composite output image 208 includes the digital image 200, and the layering of the data-populated emblem 206 to overlap the digital image 200 is non-destructive to the digital image 200, e.g., the pixel content of the digital image 200 does not differ from the original pixel content of the digital image 200 when the digital image 200 is included by the composite output image 208.

Combining the digital image 200 and the data-populated emblem 206 in this way results in decreased processing time and/or processing resources used to generate the composite output image 208. For example, because the composite output image 208 is formed without modifying pixels of the digital image 200, the composite output image 208 occupies a reduced amount of storage space, and a computational load associated with forming the composite output image 208 is reduced.

However, in some instances as described above, the composite output image 208 is to be used off-platform, e.g., at websites or networks external to the e-commerce platform, such as social media networks. For example, the listing management module 114 is configurable to implement a “share listing” function for generating of a preview of an item listing, and the preview is able to be employed off-platform to direct navigation of a user interface, such as a web browser, to the location of the item listing. In some instances, the preview includes a shortened description of the listed item retrieved from the item listing data 108, a hyperlink directed to the URL of the item listing, and the composite output image 208. In such scenarios, the composite output image 208 is formatted as a single, flattened image, such as a JPG, PNG, or other type of raster image incorporating the data-populated emblem 206 with the pixel content of the digital image 200. In particular, at least some of the original pixels included by the digital image 200 are updated (e.g., altered) based on the content of the data-populated emblem 206 to display the data-populated emblem 206 in the overlapping arrangement to the digital image 200. Formation of the composite output image 208 in this way increases an ease of reliably displaying the composite output image 208 at off-platform locations.

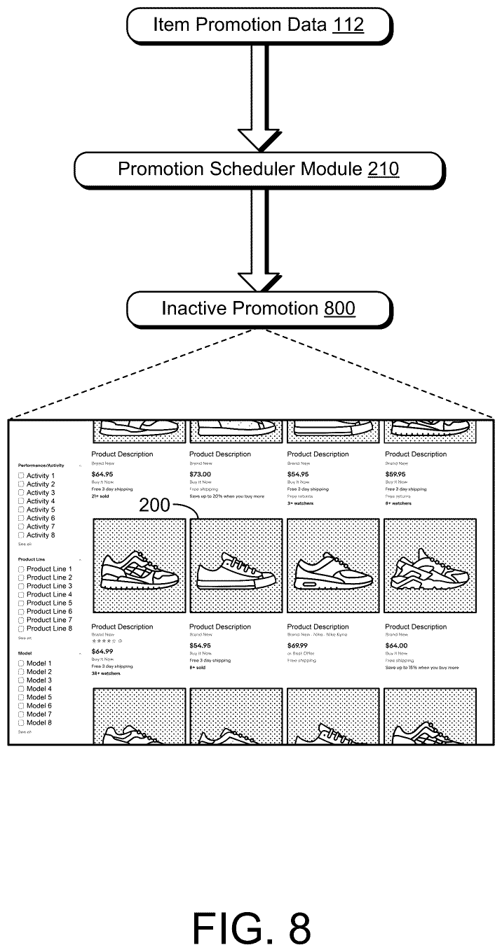

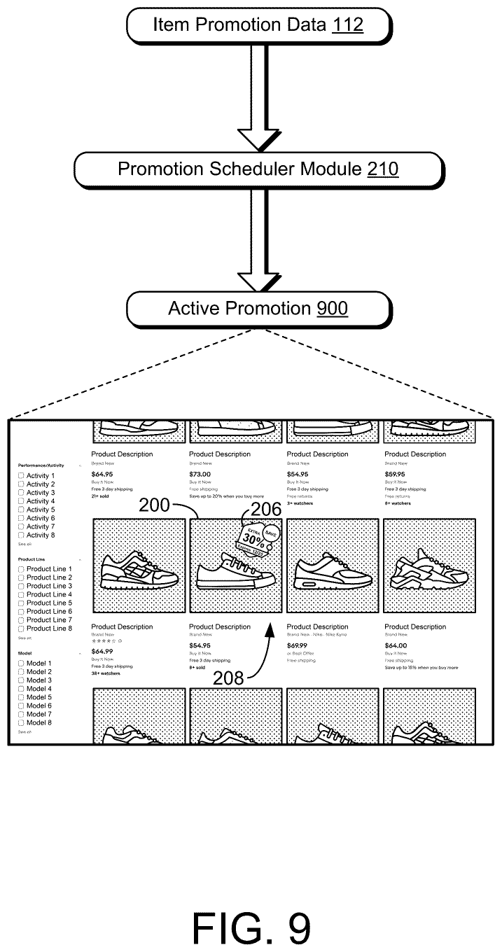

The promotion scheduler module 210 receives the composite output image 208, and the promotion management module 116 controls deployment of the composite output image 208 via the promotion scheduler module 210 based on the promotion parameters defined by the item promotion data 112 (block 1114). For example, during conditions in which the promotion is active, the promotion scheduler module 210 updates the listing data to include the composite output image 208 in the item listing. During conditions in which the promotion is inactive, the promotion scheduler module 210 configures the item listing such that the composite output image 208 is not included within the listing data. In some instances, the promotion management module 116 delays generation of the composite output image 208 until the promotion is active. The determination of whether the promotion is active or inactive is based on the item promotion data 112, and an example is described further below with reference to FIGS. 8-9.

The presentation module 120 receives data from the promotion scheduler module 210. The presentation module 120 then facilitates the display of the item listing with the active or inactive promotion to external computing devices, such as computing device 124, via network 122.

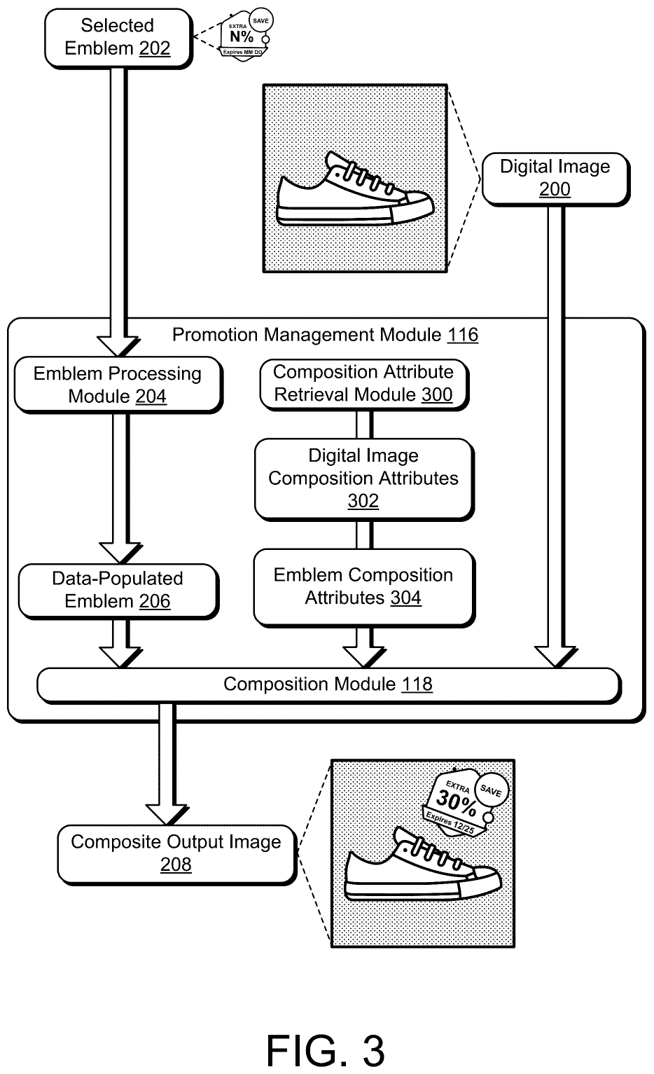

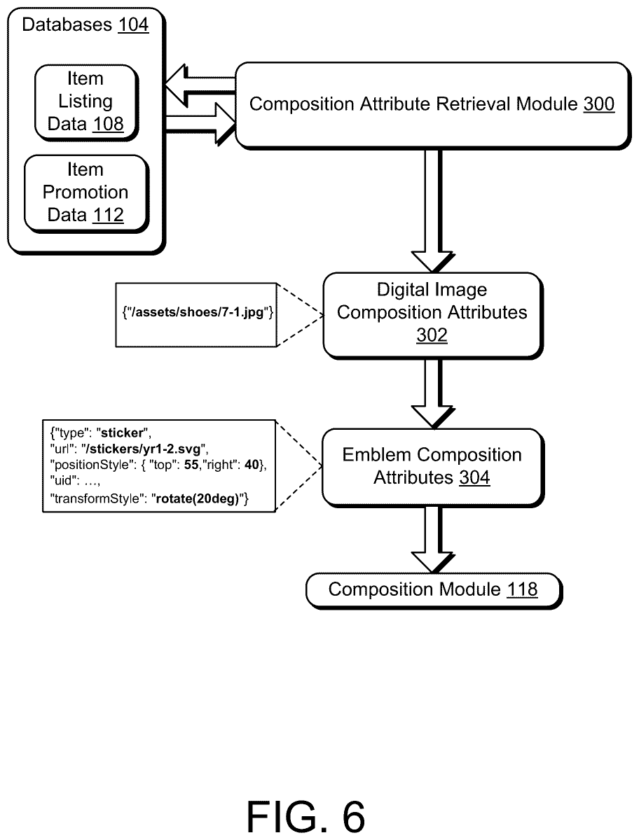

Referring to FIG. 3, another example implementation is depicted showing operation of the promotion management module 116 in greater detail. In the depiction, the selected emblem 202 is provided to emblem processing module 204, which processes the selected emblem 202 to form the data-populated emblem 206 as described above. The data-populated emblem 206 and the digital image 200 are each provided to composition module 118 to form the composite output image 208 as described above. However, FIG. 3 additionally depicts composition attribute retrieval module 300 that provides output to adjust appearance attributes of the digital image 200 and/or the selected emblem 202 for forming the composite output image 208 via the composition module 118. An example implementation of composition attribute retrieval module 300 is shown in greater detail by FIG. 6.

The composition attribute retrieval module 300 retrieves digital image composition attributes 302 and emblem composition attributes 304 and provides the attributes to composition module 118. The digital image composition attributes 302 and the emblem composition attributes 304 are defined by the item listing data 108 and the item promotion data 112, respectively, in some instances.

The digital image composition attributes 302 include, for example, a web address, or uniform resource locator (URL), of the digital image 200. In some instances, the composition module 118 retrieves the digital image 200 using the URL of the digital image 200. The digital image composition attributes 302 further include, in some instances, data describing a size of the digital image 200 (e.g., width and height) and/or orientation of the digital image 200.

The emblem composition attributes 304 include, for example, a URL of the selected emblem 202. In some instances, the composition module 118 retrieves the selected emblem 202 using the URL of the selected emblem 202. The emblem composition attributes 304 further include, in some instances, data describing a size of the selected emblem 202 and/or an orientation of the selected emblem 202. The emblem composition attributes 304, for example, describing the size and orientation of the selected emblem 202 are based on the item promotion data 112 and are configured during setup of the item promotion. During creation of the item promotion, the emblem composition attributes 304 describing the size, position, and orientation of the selected emblem 202 relative to the digital image 200 are definable based on user input applied to promotion parameter interface 702 described further below with reference to FIG. 7.

The composite output image 208 is based at least in part on the digital image composition attributes 302 and the emblem composition attributes 304. In particular, the composition module 118 receives the selected emblem 202 and the digital image 200 and combines the selected emblem 202 with the digital image 200 to form the composite output image 208 using the digital image composition attributes 302 and the emblem composition attributes 304.

Consider an example in which the digital image composition attributes 302 include a size attribute having a value inherited from the digital image 200, such as five-hundred pixels in the horizontal direction and five-hundred pixels in the vertical direction, and a rotation attribute having a value of zero degrees of rotation. In the example, the emblem composition attributes 304 include a size attribute of the selected emblem 202 (and by extension, the data-populated emblem 206) having a value of fifty pixels in the horizontal direction and fifty pixels in the vertical direction, a rotation attribute having a value of twenty degrees of rotation, and a position attribute having a value of a ten-pixel horizontal offset and a ten-pixel vertical offset.

When combining the digital image 200 with the data-populated emblem 206 in this example, the composition module 118 scales the data-populated emblem 206 to fifty pixels in the horizontal direction by fifty pixels in the vertical direction. The composition module 118 also rotates the data-populated emblem 206 by twenty degrees and offsets the data-populated emblem 206 toward the center of the digital image 200 from the top-right corner of the digital image 200 by ten pixels in the horizontal direction and ten pixels in the vertical direction. A size of the composite output image 208 is five-hundred pixels in the horizontal direction and five-hundred pixels in the vertical direction.

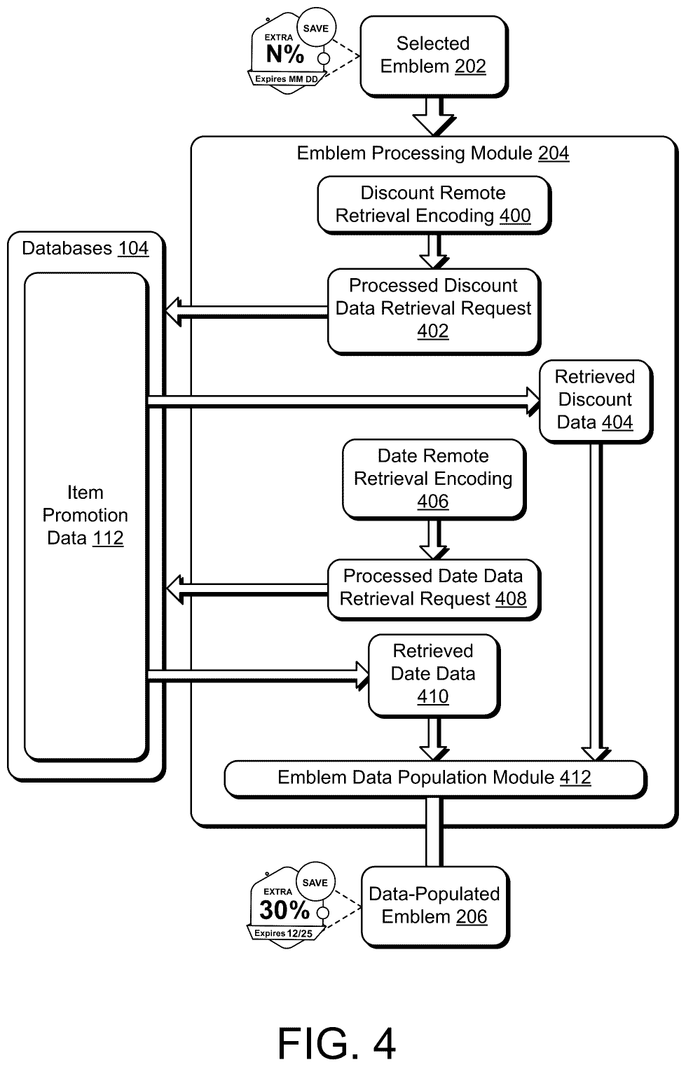

Referring to FIG. 4, another example implementation is depicted showing operation of the promotion management module 116 in greater detail. In the example shown, selected emblem 202 is provided to emblem processing module 204 as described above. The emblem processing module 204 processes an encoding of the selected emblem 202 to populate the selected emblem 202 with promotion parameters described by item promotion data 112. The output of emblem processing module 204 is the data-populated emblem 206.

To do so, the emblem processing module 204 processes a discount remote retrieval encoding 400 of the selected emblem 202. The discount remote retrieval encoding 400 is an embedded encoding within the selected emblem 202, e.g., interlaced with encoding defining the selected emblem 202 such as emblem text encoding 502 described below. In some instances, the discount remote retrieval encoding 400 is stored within a discount data field within the encoding of the selected emblem 202. The discount remote retrieval encoding 400 is formatted to include a JSON object targeting, or directed toward, promotion discount data included within the item promotion data 112, in some instances. As one example, the discount remote retrieval encoding 400 is configured as a JavaScript function including the JSON object, and once processed (e.g., executed), the function causes the emblem processing module 204 to generate a processed discount data retrieval request 402.

In some instances, the processed discount data retrieval request 402 is included within an electronic communication transmitted by the emblem processing module 204 to databases 104 to retrieve item discount data from the item promotion data 112. Responsive to receiving the processed discount data retrieval request 402, the databases 104 transmit an electronic communication to the emblem processing module 204 including the retrieved discount data 404 from the item promotion data 112. In other instances, the emblem processing module 204 retrieves the item promotion data 112 prior to execution of the discount remote retrieval encoding 400. The emblem processing module 204, for instance, identifies an index of the item promotion data 112 based on an index of the item listing data 108 as described above and retrieves the item promotion data 112 via a request to databases 104 using the index of the item promotion data 112. The item promotion data 112 is then loaded to memory or a buffer, and the processed discount data retrieval request 402 retrieves the discount data from the memory or buffer.

The retrieved discount data 404 is provided to emblem data population module 412. The emblem data population module 412 updates the selected emblem 202 to include the retrieved discount data 404 within a graphical promotion discount field of the selected emblem 202 as described further below. In some instances, the retrieved discount data 404 replaces the discount remote retrieval encoding 400 within the encoding of the selected emblem 202. For example, the retrieved discount data 404 is embedded within the encoding of the selected emblem 202 and the discount remote retrieval encoding 400 is overwritten.

The emblem processing module 204 additionally processes a date remote retrieval encoding 406. The date remote retrieval encoding 406 is embedded within the selected emblem 202, e.g., interlaced with encoding defining the selected emblem 202 such as emblem text encoding 502 described below. In some instances, the date remote retrieval encoding 406 is stored within a date data field within the encoding of the selected emblem 202. The date remote retrieval encoding 406 is formatted to include a second JSON object targeting, or directed toward, promotion date data included within the item promotion data 112, in some instances. As one example, the date remote retrieval encoding 406 is configured as a second JavaScript function including the second JSON object. Once processed (e.g., executed), the function causes the emblem processing module 204 to generate a processed date data retrieval request 408.

In some instances, the processed date data retrieval request 408 is included within an electronic communication transmitted by the emblem processing module 204 to databases 104 to retrieve item promotion start date and item promotion end date data from the item promotion data 112. Responsive to receiving the processed date data retrieval request 408, the databases 104 transmit an electronic communication to the emblem processing module 204 including the retrieved date data 410 from the item promotion data 112. In other instances, the emblem processing module 204 retrieves the item promotion data 112 prior to execution of the date remote retrieval encoding 406 and loads the item promotion data 112 to the memory or buffer as described above. The processed date data retrieval request 408 retrieves the date data from the memory or buffer.

The retrieved date data 410 is provided to emblem data population module 412, which updates the selected emblem 202 to include the retrieved date data 410 within a graphical promotion date field of the selected emblem 202 as described further below. In some instances, the retrieved date data 410 replaces the date remote retrieval encoding 406 within the encoding of the selected emblem 202. For example, the retrieved date data 410 is embedded within the encoding of the selected emblem 202 and the date remote retrieval encoding 406 is overwritten.

In some instances, the electronic communication including the processed discount data retrieval request 402 is combined with the electronic communication including the processed date data retrieval request 408 as a single electronic communication. In response to receiving the electronic communication from the emblem processing module 204, the databases 104 transmit the retrieved discount data 404 and the retrieved date data 410 together to the emblem processing module 204. By processing the selected emblem 202 via the emblem processing module 204, the emblem processing module 204 outputs data-populated emblem 206 for use with a promotion of a listed item as described above.

Referring to FIG. 5, an example encoding of selected emblem 202 is depicted. As described above, the selected emblem 202 includes encoding that defines properties of the selected emblem 202, such as the shape of the selected emblem 202, color of various portions of the selected emblem 202, and text displayed within graphical data fields of the selected emblem 202. The various properties of the selected emblem 202 are defined by strings and values included within the encoding of the selected emblem 202. The selected emblem 202 is readable by a user interface, such as a website browser, for display of graphical content of the selected emblem 202, such as the various shapes and text defined by the encoding of the selected emblem 202. The encoding of the selected emblem 202 thus defines the properties of the selected emblem 202 and the visual appearance of the selected emblem 202 while the selected emblem 202 is displayed via a user interface such as a website browser. Although an example of the selected emblem 202 is shown by FIG. 5, in some instances the shape, size, relative arrangement of features, and other properties of the emblem have a different configuration.

In the example shown, the selected emblem 202 includes emblem shape encoding 500 defining graphical features of the selected emblem 202 such as the shapes of various features of the selected emblem 202, colors of the features of the selected emblem 202, a size and/or position of the graphical features of the selected emblem 202, and so forth. The selected emblem 202 further includes emblem text encoding 502 defining text elements shown by the selected emblem 202. In particular, the text elements shown by the selected emblem 202 include promotion parameters such as promotion discount amount, promotion start date, and promotion end date, in some instances during conditions in which the selected emblem 202 is populated with data from the item promotion data 112.

In the example, the text elements shown by the selected emblem 202 further include the words “SAVE,” “EXTRA,” and “Expires,” although in other configurations different text elements are possible. In this example, the words “SAVE,” “EXTRA,” and “Expires” are static text elements of the selected emblem 202 and are displayed alongside graphical features of the selected emblem 202 independent of data included in the item promotion data 112.

For example, consider a scenario in which the selected emblem 202 is used in a first promotion of an item listed by listing management module 114 of FIG. 1. The promotion parameters included within the item promotion data 112 for the first promotion define an item promotion discount amount of “30%,” a promotion start date of “Dec. 1, 2023,” and a promotion end date of “Dec. 25, 2023.” During conditions in which the selected emblem 202 is populated with the promotion data associated with the first promotion, the emblem displays the static text elements (“SAVE,” “EXTRA,” and “Expires”) as well as the promotion discount amount of 30% at graphical discount data field 508 and the promotion end date of Dec. 25, 2023 at the graphical date data field 510.

However, following the first promotion and during a second promotion of the same listed item, the promotion parameters included within the item promotion data 112 for the second promotion define the item promotion discount amount as 50% and the promotion end date as Dec. 31, 2023. During conditions in which the selected emblem 202 is populated with the promotion data associated with the second promotion, the emblem displays the static text elements (“SAVE,” “EXTRA,” and “Expires”) as well as the promotion discount amount of “50%” at graphical discount data field 508 and the promotion end date of “Dec. 31, 2023” at the graphical date data field 510. Thus, the static text elements are configured independently of the item promotion data 112, and changes to the item promotion data 112 such as different item promotion discount amounts or promotion end dates do not alter the static text elements. Further, the selected emblem 202 is shown as one instance of an emblem, and each item listing is configurable to include a separate instance of the emblem with the same static text elements and different promotion data.

The promotion discount field 504 of the selected emblem 202 includes an encoding that defines the visual appearance of the graphical discount data field 508 during conditions in which the selected emblem 202 is viewed within a user interface such as a website browser. Additionally, the promotion date field 506 of the selected emblem 202 includes an encoding that defines the visual appearance of the graphical date data field 510 during conditions in which the selected emblem 202 is viewed within the user interface. In some instances, the encoding defines a typeface, color, size, or other visual parameters of information (e.g., data) displayed via the graphical date data field 510 and/or the graphical discount data field 508.

Referring to FIG. 6, an example implementation of composition attribute retrieval module 300 is shown in greater detail as described above. FIG. 6 depicts examples of digital image composition attributes 302 and emblem composition attributes 304 used by composition module 118 in forming the composite output image 208 as described above. The composition module 118 in some instances formats the composite output image 208 as a DIV element or other type of HTML element that includes the data-populated emblem 206 in the overlapping arrangement with the digital image 200. The emblem composition attributes 304 shown are appended to the DIV element in some instances to control the position, rotation, etc. of the data-populated emblem 206 relative to the digital image 200 in accordance with the parameters described by the emblem composition attributes 304. Further, the digital image composition attributes 302 are appended to the DIV element in some instances to control the size and/or orientation of the digital image 200 within the DIV element. The DIV element thus groups the data-populated emblem 206 and the digital image 200 together in the arrangement specified by the digital image composition attributes 302 and the emblem composition attributes 304.

Referring to FIG. 7, another example implementation of promotion management module 116 is shown in greater detail. In the example, promotion management module 116 employs promotion parameter interface 702 for determining promotion parameters of a listed item. In some instances, promotion parameter interface 702 is accessible by external computing devices, such as computing device 124 shown by FIG. 1, through presentation module 120, also shown by FIG. 1. For example, presentation module 120 is configurable to communicate electronically with promotion management module 116 for the display of promotion parameter interface 702. Promotion parameter interface 702 is a website or portion of a website, in some instances, employed by promotion management module 116 for configuring promotion parameters of a listed item.

The promotion parameter interface 702 receives input 700. Input 700 in some instances includes user input applied via a user interface device such as a mouse, keyboard, or other type of user interface device applied to promotion parameter interface 702 for selection of promotion parameters. In some examples, input 700 is provided at a computing device external to the service provider system 102 and promotion management module 116, such as computing device 124 shown by FIG. 1, where the external computing device is in electronic communication with the service provider system 102 and promotion management module 116 as described above. Electronic communication includes, in some instances, wired and/or wireless communication.

The promotion parameter interface 702 includes a variety of fields that are populatable via input 700 to define promotion parameters of an item listed by listing management module 114. The promotion management module 116 in some instances transmits the promotion parameters input to the promotion parameter interface 702 for storage of the promotion parameters as item promotion data 112 within databases 104. In particular, the promotion parameter interface 702 is populatable with promotion parameters based on input 700. An example is shown through the transition of promotion parameter interface 702 to populated promotion parameter interface 704. The promotion parameters within populated promotion parameter interface 704 are stored to the item promotion data 112 via electronic communication between the promotion management module 116 and databases 104. The promotion parameter interface 702 therefore supports customization of promotion parameters of a listed item based on input 700. In some instances, the promotion parameter interface 702 supports the input of an active promotion pause indication, with the active promotion pause indication being stored within the item promotion data 112.

Referring to FIGS. 8-9, another example implementation of promotion management module 116 is shown in greater detail. Item promotion data 112 is provided to promotion scheduler module 210, similar to the examples described above. The promotion management module 116 determines a current date (block 1202 of FIG. 12). The promotion management module 116 further identifies the promotion start date and promotion end date included in the item promotion data 112 (block 1204 of FIG. 12). The promotion management module 116 determines whether the current date is between the promotion start date and the promotion end date (block 1206 of FIG. 12). The current date, as determined by the promotion management module 116, is based on Universal Time Coordinated (UTC), also referred as Coordinated Universal Time, using Network Time Protocol (NTP), in some instances.

The promotion management module 116 further determines whether the item promotion data 112 includes an active promotion pause indication (block 1208 of FIG. 12). In some instances, the item promotion data 112 includes a promotion pause data field that is configurable to have a True value or a False value, with the True value representing an active promotion pause indication and with the False value representing an inactive promotion pause indication.

In the example depicted by FIG. 8, the promotion scheduler module 210 determines that the current date is outside of a date range defined between the promotion start date and the promotion end date of the item promotion data 112. The date range is defined as inclusive of the promotion start date, the promotion end date, and each date between the promotion start date and the promotion end date, without including dates that are not between the promotion start date and the promotion end date. As a result, the promotion scheduler module 210 outputs inactive promotion 800 (block 1214 of FIG. 12).

Outputting the inactive promotion 800 includes configuring the item listing to display the digital images of the item listing without promotion emblems (block 1216 of FIG. 12). For example, the digital images are displayed without the selected emblem 202 from the examples described above. Further, outputting the inactive promotion 800 includes configuring the item listing to not display the item promotion data 112. In this example the promotion scheduler module 210 determines that the current date is outside of the date range between the promotion start date and the promotion end date. In other examples, the promotion scheduler module 210 outputs the inactive promotion 800 responsive to determining that the item promotion data 112 includes the active promotion pause indication.

During conditions in which the promotion scheduler module 210 determines that the current date is between the promotion start date and the promotion end date and the item promotion data 112 does not include an active promotion pause indication, the promotion scheduler module 210 outputs an active promotion (block 1210 of FIG. 12), similar to the example of active promotion 900 shown by FIG. 9. Outputting the active promotion includes outputting a composite image, such as composite output image 208 described above, visually indicating the promotion parameters according to the techniques described herein (block 1212 of FIG. 12). The composite image is also referred to herein as a combined image. For example, during conditions in which the promotion scheduler module 210 outputs the active promotion 900, the item listing to which the active promotion 900 is applied is updated by the promotion scheduler module 210 to display a promotion emblem, such as data-populated emblem 206, in an overlapping arrangement with the digital image representing the listed item, such as digital image 200.

By controlling deployment of the promotion according to the promotion data as described above, the promotion scheduler module 210 is configured to automatically output the active promotion or inactive promotion without additional user input. As a result, the promotion management module 116 increases an ease of managing promotions. In some instances, the service provider system 102 including the promotion management module 116 supports various other operations as described below.

As one example, the promotion management module 116 supports changes to the shape of the emblem displayed in the overlapping arrangement. The digital image of an item listing is based on a difference between the current date (determined by the promotion management module 116 as described above) and the promotion end date of a promotion of the listed item. For example, as the difference between the current date and the promotion end date decreases and/or transitions to an amount smaller than a threshold difference, the promotion management module 116 is configurable to automatically replace the selected emblem with an updated version of selected emblem or another emblem different than the selected emblem.

As another example, the promotion management module 116 supports inclusion of additional data in the promotion data that is utilized when certain conditions are satisfied. For example, as the end date of a promotion approaches the current date, the promotion management module 116 replaces text populating the graphical data fields of the selected emblem with updated text included in the promotion data to indicate the upcoming promotion end date. In some instances, the promotion management module 116 updates the selected emblem to include additional text included in the promotion data based on the amount of time between the current date and the approaching promotion end date, such as updating the emblem to display “ENDING SOON” while retaining the original promotion text populating the emblem.

In a further example, the promotion management module 116 supports updates to the emblem composition attributes based on a difference between the current date and the promotion start date or promotion end date, such as updating the attributes to enlarge or rotate the emblem as the current date approaches the promotion end date.

In yet another example, the promotion management module 116 supports updates to the emblem responsive to changes in the discount amount, or scheduling automatic updates to the discount amount based on the difference between the current date and the promotion end date and/or promotion start date. For example, the promotion management module 116 is configurable to increase the discount amount shown in the graphical data fields of the emblem as the current date approaches the promotion end date.

Additionally, the promotion management module 116 supports application of the same promotion data to multiple item listings such that a promotion of a first listed item starts at a same time as a promotion of a second listed item with the same discount amounts and other promotion parameters. Promotion data for multiple listings is included as a single entry in the promotion dataset in some examples, reducing database load and network traffic in some instances.

Yet further, the promotion management module 116 supports updates to the color of the emblem and/or the color of the text displayed by the emblem based on a difference between the current date and the promotion end date and/or promotion start date. For example, as the current date approaches the promotion end date, a color of the emblem is shifted by the promotion management module 116 from a first color to a second color based on the amount of time between the current date and the promotion end date.

The promotion management module 116 is also configurable to support a promotion to be maintained for a set amount of time (e.g., 7 days), without setting a specific promotion end date. The promotion management module 116 also supports extension of a length of the promotion of a listed item. Extending the length of the promotion in some instances also results in the promotion management module 116 updating the shape and/or color of the promotion emblem and/or text included in the graphical data fields of the promotion emblem.

Although display of a single promotion for a single item listing is described in the examples above, the service provider system 102 supports the concurrent display of multiple item listings, with a respective promotion applied to each item listing. The different promotions are configurable with different promotion parameters, e.g., different displayed emblems. The listing management module 114 supports operations to sort listings. The listing, for instance, are sortable based on the type of promotion emblem applied to item listings, the amount of time between the current date and the respective promotion end date of different listings, the promotion discount rate of different listings, and so forth. The promotion management module 116 also supports custom user-created promotion emblems formed according to promotion emblem criteria defined by the promotion management module 116. For example, the promotion management module 116 is configurable to support upload of user-created SVG emblems and modification of the user-created SVG emblems to include data fields including the promotion data retrieval encoding described above. The listing management module 114 is configurable to support operations that group multiple listings together, such as to form a cluster or library of item listings. In the example, the promotion management module 116 is employed to apply a single selected promotion emblem to a digital image representing the grouping to indicate that each listing within the grouping includes the promotion parameters specified by the promotion emblem.

As another example, the promotion management module 116 supports edits to a text size and/or typeface associated with the display of the promotion parameters via the promotion emblem. The text size and/or typeface are customizable based on user input in some instances.

In a further example, the promotion management module 116 supports selection of the shape of the promotion emblem applied to an item listing. The selection of the shape, for instance, is based on a category to which the listed item belongs, e.g., a sport emblem for sports equipment, a gaming emblem for a gaming item, etc.

In yet another example, the promotion management module 116 supports animation of the promotion emblem and hover-over transitions of the promotion emblem. Examples of the transition include fading in/out, size change, color change, showing additional shapes/emblem sections, and so forth, without affecting the digital image layered beneath the promotion emblem.

An overlapping arrangement of elements as described herein refers to a configuration of the elements that results in visual overlapping of the elements during conditions in which the elements are rendered. For example, as described above, an item listing is configurable as a webpage. The webpage is formatted as an HTML document, in some instances. The HTML document is renderable via an application such as a web browser, with the application reading an encoding of the HTML document and rendering elements specified by the HTML document based on the content of the encoding. The content of the encoding includes various elements such as DIV elements, tables, and so forth, and parameters of each element are configurable to control the relative arrangement of the elements when the HTML document is rendered.

Consider a scenario in which the HTML document includes an IMG tag specifying a URL of the digital image 200. During conditions in which the HTML document is rendered, the application rendering the HTML document reads the IMG tag with the URL of the digital image 200 and retrieves (e.g., downloads) the digital image 200 from the location specified by the URL of the digital image 200. The digital image 200 is rendered (e.g., displayed) within the application at the location specified by the encoding of the HTML document. For example, the encoding of the HTML document is configurable to specify the position of the rendered digital image 200 within an x-y coordinate space of a graphical user interface (GUI) of the application when the GUI is displayed by a display screen. The HTML document is also configurable with encoding that results in rendering of other elements within the GUI of the application when the HTML document is read by the application. In particular, the HTML document is configurable to display the data-populated emblem 206 at a specified position within the x-y coordinate space of the GUI of the application when the HTML document is read by the application and the GUI is displayed by the display screen. The specified position of the data-populated emblem 206 is based on the emblem composition attributes 304 in some instances.

The encoding of the HTML document is also configurable to specify a z-order of the elements to be rendered via the application. The z-order refers to a visual ordering of the elements in a direction normal to the plane of view of the GUI. An element with a lower z-order value is rendered visually beneath an element with a higher z-order value. During conditions in which two or more elements at least partially occupy a same location within the x-y coordinate space of the GUI when the HTML document is read by the application, the z-order value of each element determines the position of each element with respect to the plane of view.

Consider an example in which a first element (e.g., the digital image 200) has a lower, first z-order value, and a second element (e.g., the data-populated emblem 206) has a higher, second z-order value. Further, the location of the second element within the x-y coordinate space at least partially occupies the location of the first element within the x-y coordinate space. When the first element and the second element are rendered, the second element appears visually closer to the plane of view than the first element. The visual features of the second element that occupy the same location within the x-y coordinate space as the visual features of the first element are referred to as overlapping the features of the first element. In an example in which the second element includes opaque visual features such as solid fills without transparency or blending effects, the opaque visual features of the second element overlap visual features of the first element and obscure the overlapped visual features of the first element. Transparent or translucent visual features of the second element that overlap visual features of the first element do not fully obscure the visual features of the first element.

In the example, while the second element at least partially overlaps the first element, the overlap of the second element with the first element is non-destructive to the first element. Non-destructive overlapping, as described herein, refers to the maintaining the first element and the second element as separate entities that each occupy at least a portion of the same location within the x-y coordinate space of the GUI when rendered. In particular, the second element is rendered to appear visually closer to the plane of view while the first element is rendered to appear visually behind the second element relative to the plane of view. In this configuration, visual features of the second element overlap visual features of the first element and obscure the visual features of the first element. However, the overlapping of the first element and the second element does not modify content (e.g., pixel content, vector content, etc.) of the first element or the second element. Specifically, although the second element is rendered closer to the plane of view, the portions of the second element that overlap portions of the first element do not delete, remove, or otherwise alter the content of the first element.

For example, in a scenario in which the first element is the digital image 200 and the second element is the data-populated emblem 206, overlapping of the data-populated emblem 206 with the digital image 200 in the non-destructive arrangement causes the data-populated emblem 206 to obscure portions of the digital image 200 within the GUI. However, the overlapping in the non-destructive arrangement does not alter the content of the digital image 200 (e.g., pixel content). The digital image 200 is configurable as a JPEG image in some instances, and the non-destructive overlapping does not alter the number of pixels, color of pixels, or file size of the JPEG image. Although a JPEG image is described as an example, the digital image 200 is some instances is configured as a different type of image such as a PNG, TIF, GIF, or the like.

As an example, FIG. 9 shows the data-populated emblem 206 in an overlapping arrangement to the digital image 200. The digital image 200 is shown with a background having a coloration or appearance indicated by stipple shading, where the background is formed by pixels of the digital image 200. The overlapping arrangement shown is non-destructive to the digital image 200, such that the overlapping of the data-populated emblem 206 obscures portions of the digital image (e.g., the pixels of the digital image forming the background) but does not remove, replace, or otherwise alter the pixels themselves. However, the z-order value of the data-populated emblem 206 is greater than the z-order value of the digital image 200 such that the data-populated emblem 206 is rendered to appear closer to the plane of view than the digital image 200. This rendering gives the data-populated emblem 206 the appearance of being layered on top of the digital image 200 without processing the digital image 200 to alter the pixel content of the digital image 200. Once the promotion associated with the data-populated emblem 206 is paused or concluded (similar to the example shown by FIG. 8), the data-populated emblem 206 is not displayed and the entire digital image 200 is once again revealed. This simplifies management of promotions because the promotion emblems can be displayed or removed without altering the digital images that the promotion emblems overlap, thereby reducing consumption of memory or other resources that would otherwise be used to alter the digital images.

### Example System and Device

Referring to FIG. 10, an example system 1000 is depicted that includes an example computing device that is representative of one or more computing systems and/or devices that are usable to implement the various techniques described herein. This is illustrated through inclusion of the service provider system 102 including promotion management module 116. Computing device 1002 includes, for example, a server of service provider system 102, a device associated with a client (e.g., a client device), an on-chip system, and/or any other suitable computing device or computing system.

The example computing device 1002 as illustrated includes a processing system 1004, one or more computer-readable media 1006, and one or more input/output interfaces 1008 (I/O interfaces) that are communicatively coupled, one to another. Although not shown, the computing device 1002 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that are configured as processors, functional blocks, and so forth. This includes example implementations in hardware as a system specific integrated circuit or other logic device formed using one or more semiconductors. The hardware elements 1010 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1006 is illustrated as including memory/storage 1012. The memory/storage 1012 represents memory/storage capacity associated with one or more computer-readable media. In one example, the memory/storage 1012 includes volatile media (such as random access memory (RAM)) and/or nonvolatile media (such as read only memory (ROM), Flash memory, optical disks, magnetic disks, and so forth). In another example, the memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow user input to enter commands and information to computing device 1002, and also allow information to be presented and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The one-or-more computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, a system-specific integrated circuit (ASIC), a field-programmable gate array (FPGA), a complex programmable logic device (CPLD), and other implementations in silicon or other hardware. In this context, hardware operates as a computing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1010. For example, the computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supportable by various configurations of the computing device 1002 and are not limited to the specific examples of the techniques described herein. This functionality is also implementable entirely or partially through use of a distributed system, such as over a “cloud” 1014 as described below.

The cloud 1014 includes and/or is representative of a platform 1016 for resources 1018. The platform 1016 abstracts underlying functionality of hardware (e.g., servers) and software resources of the cloud 1014. For example, the resources 1018 include systems and/or data that are utilized while computer processing is executed on servers that are remote from the computing device 1002. In some examples, the resources 1018 also include services provided over the Internet and/or through a subscriber network, such as a cellular or Wi-Fi network.

The platform 1016 abstracts the resources 1018 and functions to connect the computing device 1002 with other computing devices. In some examples, the platform 1016 also serves to abstract scaling of resources to provide a corresponding level of scale to encountered demand for the resources that are implemented via the platform. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter. Further, various different examples are described and it is to be appreciated that each described example is implementable independently or in connection with one or more other described examples.

What is claimed is:

1. A method for item listing promotion management implemented by a computing device, comprising:
receiving, by the computing device, a digital image of an item and a promotion emblem;
identifying, by the computing device, promotion data of the item from a promotion dataset;
identifying, by the computing device, a graphical promotion data field of the promotion emblem;
populating, by the computing device, the graphical promotion data field with the promotion data of the item via execution of instructions stored within an encoding of the promotion emblem;
forming, by the computing device, a combined image by combining the promotion emblem including the graphical promotion data field populated with the promotion data of the item with the digital image in an overlapping arrangement non-destructive to the digital image; and
outputting, by the computing device, the combined image for display in a user interface.

2. The method as described in claim 1, wherein populating the graphical promotion data field with the promotion data of the item via the execution of the instructions stored within the encoding of the promotion emblem includes processing remote retrieval encoding embedded in the promotion emblem to retrieve the promotion data of the item from the promotion dataset and embed the promotion data of the item within the encoding of the promotion emblem.

3. The method as described in claim 1, wherein the promotion emblem is formatted as a vector image and the digital image is formatted as a raster image.

4. The method as described in claim 1, wherein the promotion emblem is a scalable vector graphic (SVG) image and the instructions stored within the encoding of the promotion emblem are formatted as JavaScript Object Notation (JSON) objects interlaced with encoding defining the SVG image.

5. The method as described in claim 4, wherein the JSON objects include a promotion date object and a promotion discount object.

6. The method as described in claim 1, wherein a position and an orientation of the promotion emblem relative to the digital image is defined based on emblem composition attributes included in the promotion data.

7. The method as described in claim 6, wherein combining the promotion emblem including the graphical promotion data field populated with the promotion data of the item with the digital image in the overlapping arrangement non-destructive to the digital image includes layering the promotion emblem in the overlapping arrangement with the digital image within a HyperText Markup Language (HTML) element based on the emblem composition attributes.

8. The method as described in claim 7, wherein receiving the promotion emblem includes downloading the promotion emblem as a string, and layering the promotion emblem in the overlapping arrangement with the digital image within the HTML element based on the emblem composition attributes includes appending the string to the HTML element.

9. The method as described in claim 1, wherein identifying the promotion data of the item from the promotion dataset includes identifying a promotion start date, a promotion end date, and a promotion discount amount of the item.

10. The method as described in claim 1, further comprising flattening the combined image as a single raster image via a composite Application Programming Interface (API) subsequent to the forming.

11. The method as described in claim 1, wherein outputting the combined image for display in the user interface includes replacing the digital image in a listing of the item with the combined image.

12. A method for item listing promotion management implemented by a computing device, comprising:
receiving, by the computing device, a listing of an item on an electronic commerce platform, the listing including:
promotion data describing promotion parameters of the item;
a digital image of the item; and
an emblem including a graphical promotion data field;
processing, by the computing device, an encoding of the emblem to replace the graphical promotion data field with the promotion data in the listing;
generating, by the computing device, a combined image formed from the digital image of the item and the emblem; and
controlling, by the computing device, deployment of the combined image within the listing based on the promotion parameters.

13. The method of claim 12, wherein processing the encoding of the emblem includes executing computer-readable instructions stored within the encoding that define objects targeting the promotion data.

14. The method as described in claim 13, wherein the objects include a promotion date object and a promotion discount object.

15. The method as described in claim 12, wherein controlling the deployment of the combined image within the electronic commerce platform based on the promotion parameters includes determining a current date based on Universal Time Coordinated (UTC), and comparing the current date to a promotion start date and a promotion end date defined by the promotion data.

16. The method as described in claim 15, wherein controlling the deployment of the combined image within the electronic commerce platform based on the promotion parameters further includes:
determining whether the current date is within a range of dates between the promotion start date and the promotion end date, the range of dates inclusive of the promotion start date and the promotion end date;
determining whether the promotion data includes an active promotion pause indication; and
responsive to determining that the current date is within the range of dates and determining that the promotion data does not include the active promotion pause indication, displaying the combined image within the electronic commerce platform.

17. The method as described in claim 12, wherein generating, by the computing device, the combined image formed from the digital image of the item and the emblem includes defining a position, size, or rotation of the emblem relative to the digital image based on emblem display attributes included in the promotion data.

18. A system, comprising:
one or more computing devices; and
one or more computer-readable storage media storing instructions which, when executed by the one or more computing devices, cause the one or more computing devices to perform operations comprising:
receiving a digital image of an item;
receiving a promotion emblem;
identifying promotion data of the item from a promotion dataset;
identifying a graphical promotion data field of the promotion emblem;
populating the graphical promotion data field with the promotion data of the item via execution of instructions stored within an encoding of the promotion emblem; and
forming a combined image by combining the promotion emblem including the graphical promotion data field populated with the promotion data of the item with the digital image.

19. The system as described in claim 18, wherein the instructions further comprise:
controlling deployment of the combined image within an electronic commerce platform based on the promotion data by:
determining a current date based on Universal Time Coordinated (UTC);
determining whether the current date is within a range of dates between a promotion start date and a promotion end date defined by the promotion data, the range of dates inclusive of the promotion start date and the promotion end date;
determining whether the promotion data includes an active promotion pause indication; and
responsive to determining that the current date is within the range of dates and determining that the promotion data does not include the active promotion pause indication, displaying the combined image.

20. The system as described in claim 18, wherein the promotion emblem is encoded as a scalable vector graphic (SVG) image, and forming the combined image alters a pixel content of the digital image responsive to a condition being satisfied and does not alter the pixel content of the digital image responsive to the condition not being satisfied.
